(19) United States
(12) Patent Application Publication
(10) Pub. No.: US 2025/0088942 A1
(43) Pub. Date: Mar. 13, 2025

(54) METHOD FOR MANAGING THE PROCESSING OF A VIDEO STREAM IN A LOCAL AREA NETWORK

(71) Applicant: ORANGE, Issy-les-Moulineaux (FR)

(72) Inventors: Hervé Marchand, CHATILLON CEDEX (FR); Mathieu RIVOALEN, CHATILLON CEDEX (FR)

(21) Appl. No.: 18/827,017

(22) Filed: Sep. 6, 2024

(30) Foreign Application Priority Data
Sep. 7, 2023 (FR) 2309428

(51) Int. Cl. H04W 40/24; H04W 84/12

(52) U.S. Cl. CPC H04W 40/248; H04W 84/12

(57) ABSTRACT

A method for managing the processing of a data stream carried out by a processing entity in a local area network including a set of data processing devices, wherein the location of the processing entity changes over time as a whole.

### CROSS-REFERENCE TO RELATED APPLICATIONS

This application claims priority to French Application No. 2309428, filed Sep. 7, 2023, the content of which is incorporated herein by reference in its entirety.

### TECHNICAL FIELD

The field of the invention is that of digital multimedia content items, namely digital audio and/or video content items, also called audiovisual content items.

The invention relates to a method for managing the processing of a video stream in a local area network comprising a gateway and at least one data processing device.

The processing entity is able to receive a data stream, process the data and transmit the processed data. In the example that will serve to illustrate the invention below, the processing entity is installed on a capable device and is capable of receiving data packets from a first network, of processing the data to obtain content segments and of transmitting the obtained segments to a playback device on demand. Such an entity is for example an entity capable of providing segments in “adaptive streaming” mode, without being limited thereto.

The data processing device concerns for example a playback device able to receive multimedia streams in the form of segments and to play back the received content items; such a data processing device is for example a decoder, a mobile telephone, a tablet, etc.

The communication link between the playback device and a device providing the segments may be of any nature. In the example described below, this link will be a unicast link.

A content item is for example a content item broadcast in real time, also called “live” content by those skilled in the art, or a television on demand content item, or a video on demand content item, etc.

### BACKGROUND

Nowadays, there are many modes for transmitting content from a content transmitter to a content playback device. One known mode is for example Multicast ABR (M-ABR) mode.

This M-ABR mode transports IP packets in multicast mode. In this mode, a plurality of multicast transmission channels are created for a single TV channel in order to encode and broadcast a plurality of streams with various qualities on each multicast channel, respectively. In other words, the channels broadcast one and the same content item with various image qualities, respectively.

An IP address is assigned to each channel, such that the content item is able to be accessed with a given quality by connecting to the corresponding IP address.

The M-ABR multicast mode is implemented by a processing entity nCDN. This entity is installed in a home gateway that interfaces a WAN network and a local area network. This processing entity acts as the endpoint for the multicast stream. In fact, this processing entity receives a stream of audio and/or video data transmitted from a server in multicast mode (for example with the “IPTV” (Internet Protocol television) technology) via a channel; the processing entity then stores the received packets, segments the received packets in accordance with the HAS standard, and transmits the segments in succession in unicast mode to a playback device able to play back the segments.

Since the processing entity is installed in the home gateway, the processing quality therefore depends on the processing capabilities of the gateway. It is important for the processing capabilities of the gateway to be optimum in order to best process the data stream and ensure optimum quality of service.

However, this is not always the case for multiple reasons. For example, at the time of processing, the gateway may process other data and may therefore have its processing capabilities reduced; also, the gateway may be natively inefficient in terms of processing capability for financial reasons. When the home gateway has its processing capability reduced, frozen images are observed. The rendering of the content item is therefore not optimum, and user experience is very poor.

Therefore, when the home gateway is unavailable, access to the data stream is no longer possible.

One or more aspects of the present disclosure aim to improve the situation.

### SUMMARY

To this end, an aspect of the present disclosure relates to a method for managing the processing of a data stream carried out by a management entity in a local area network comprising a set of data processing devices, characterized in that the location of the processing entity changes over time as a whole.

According to an aspect of the present disclosure, the location of the entity changes over time. More specifically, the method comprises receiving a data stream and selecting a processing location and processing the data stream in the selected device. The order in which the above steps are carried out is irrelevant.

An aspect of the present disclosure avoids using a default device to process a data stream, in this case a home gateway. The possibility of choosing a device from a set of devices as desired makes it possible, inter alia, to avoid a blocking situation linked to the unavailability of the device including the processing entity, for example because the device in question is turned off. Therefore, by processing the data stream using a device that is chosen judiciously, for example the device that has optimum processing capabilities for the intended processing, the resulting processing will necessarily be of better quality. The risks of frozen images are then greatly reduced or even no longer exist.

According to a first embodiment, the data processing device is chosen on the basis of the processing capabilities of the processing device. As indicated above, a data processing device that is chosen judiciously, here on the basis of its capabilities, i.e. the capabilities of its hardware resources and/or software resources, will make it possible to carry out better processing and therefore to ensure rendering of the content item without frozen images.

According to a second embodiment, which may be implemented as an alternative or in addition to the previous embodiment, the choice is made by comparing the processing capabilities of devices of the local area network and by selecting a device based on the comparison.

According to a third embodiment, which may be implemented as an alternative or in addition to the previous embodiments, the processing capabilities include a volatile memory size. This embodiment makes it possible to select a device equipped with a volatile memory adapted to the data stream. For example, if the data stream is a 4K video stream, the volatile memory will be selected from among the volatile memories of the various devices so as to process this stream correctly.

In another embodiment, which may be implemented as an alternative or in addition to the previous embodiments, the processing entity is able to process a data stream associated with an encoding bit rate; in this configuration, the choice of the installation location of the entity also depends on said encoding bit rate of the stream to be processed. Indeed, some streams have their encoding bit rates varied over time due to the variation in bandwidth on the network; in this case, it is advisable to take this encoding bit rate into account when choosing the volatile memory to be used, i.e. the device including this volatile memory.

According to a fourth embodiment, which may be implemented as an alternative or in addition to the previous embodiments, the local area network comprises a home gateway, and the gateway routes the data stream to the chosen processing device. In this embodiment, the gateway stores the address of the selected device on which the processing will take place; in this way, upon receipt of a multimedia stream, the gateway routes the stream to the selected device to be processed by the processing entity. If said processing entity is not available, the gateway may decide to process the received data stream.

According to a fifth embodiment, which may be implemented as an alternative or in addition to the previous embodiments, the data processing device is able to receive the data stream from a communication network. This embodiment makes it possible to select a data processing device capable of receiving the data stream from the communication network without involving the home gateway. The advantage is that, if the gateway is unavailable, the device thus selected is able to access the stream instead of the gateway.

An aspect of the present disclosure makes it possible to modify the location of the processing of the data stream over time. This makes it possible to use the most suitable device, in particular when the chosen device has its capabilities reduced. The change of device used for processing may also be based on load predictions for the devices of the local area network.

A hardware aspect relates to a management entity for managing a data stream in a local area network comprising a set of data processing devices, characterized in that it comprises a module able to request modification of the processing location in said set.

Another hardware aspect relates to a decoder comprising a management entity as defined above.

Another hardware aspect relates to a computer program able to be implemented on an entity as defined above, the program comprising code instructions that, when it is executed by a processor, carry out the steps of the selection method that are defined above.

Finally, another hardware aspect relates to a data medium on which at least one series of program code instructions for executing a management method as defined above has been stored.

Such a recording medium may be any entity or device capable of storing the program. For example, the medium may comprise a storage means, such as a ROM, for example a CD-ROM or a microelectronic circuit ROM, or even a magnetic recording means, for example a USB key or a hard disk.

On the other hand, such a recording medium may be a transmissible medium such as an electrical or optical signal, which may be routed via an electrical or optical cable, by radio or by other means, such that the computer program that it contains is able to be executed remotely. The program according to an aspect of the present disclosure may in particular be downloaded from a network, for example the Internet.

As an alternative, the recording medium may be an integrated circuit in which the program is incorporated, the circuit being designed to execute or to be used in the execution of the abovementioned management method.

### BRIEF DESCRIPTION OF THE DRAWINGS

One or more aspects of the present disclosure will be better understood on reading the following description, which is given by way of example and with reference to the appended drawings, in which:

FIG. 1 shows a computer system on which one exemplary aspect of the present disclosure is illustrated.

FIG. 2 is a simplified block diagram of the hardware structure of a playback device.

FIG. 3 is a simplified block diagram of the hardware structure of a home gateway.

FIG. 4 schematically illustrates a content item divided into segments of several qualities.

FIG. 5 illustrates one embodiment in the form of messages exchanged between the various devices involved in the management method.

### DETAILED DESCRIPTION OF ILLUSTRATIVE EMBODIMENTS

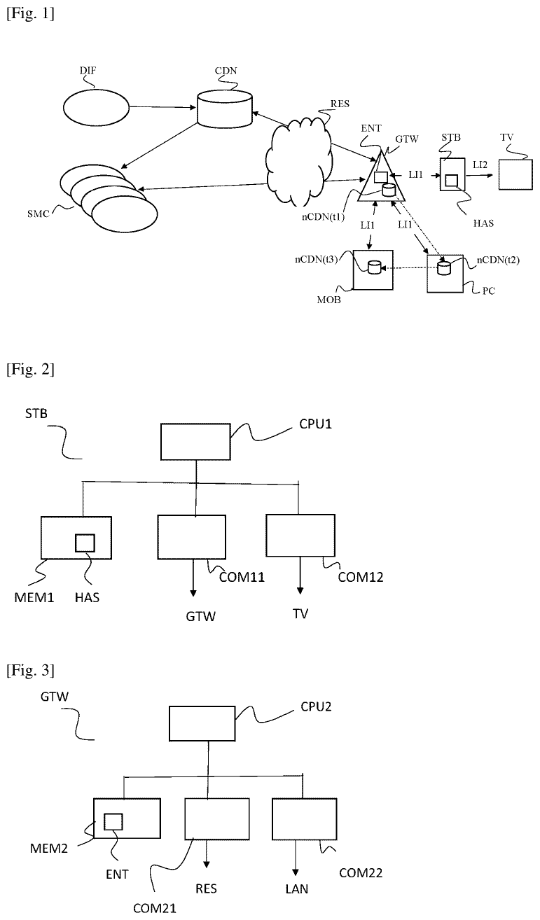

A presentation is now given, with reference to FIG. 1, of a computer system SYS including a home gateway GTW offering a local area network containing data processing devices, namely a playback device STB, for example a decoder, a computer PC and a tablet TAB.

The system SYS also comprises a data stream processing entity referenced nCDN(tk), tk being a time datum designating a given time (k is an integer in our example), for example a given day, at a given time; for example, t1 corresponds to 5 Jun. 2023 at 15:10, t2 corresponds to 12 Jun. 2023 at 16:20, etc.

It will be seen hereinafter that the location of the entity varies over time and that said entity is located at a given location at a time t1, at another location at t2 and again at another location at another time t3; hence the references nCDN(t1) to nCDN(t3) in FIG. 1.

In our example, the processing entity nCDN(tk) is able to transmit content segments to the playback device STB on demand.

FIG. 2 shows an architecture of a playback device STB. This device STB comprises, as is conventional, memories MEM1 associated with a processor CPU1. The memories may be ROMs (Read-Only Memory) or RAMs (Random Access Memory) or even flash memories.

The playback device STB may transmit a content item to be rendered to the rendering device TV via a communication module COM12. This module COM12 is for example an HDMI link.

The playback device STB communicates with the gateway via an Ethernet module for wired local communication or via a Wi-Fi radio module for wireless local communication with the home gateway GTW. The module in question is referenced CMO11 in FIG. 2.

The playback device STB comprises a streaming-mode download entity HAS able to manage the downloading of segments.

The playback device STB comprises a download module HAS. This module is able to enter into communication with a compatible data stream processing entity nCDN(tk).

FIG. 3 shows an architecture of a home gateway GTW. This device GTW comprises, as is conventional, memories MEM2 associated with a processor CPU2. The memories may be ROMs (Read-Only Memory) or RAMs (Random Access Memory) or even flash memories.

The gateway is able to communicate with devices of the local area network via a communication module COM21. This module COM21 is for example a Wi-Fi interface, an Ethernet link, or any other communication means.

The gateway is able to communicate with remote devices via a communication module COM22; in our example, the module is a WAN communication module.

In our example, the gateway stores a management entity ENT that is able, according to an aspect of the present disclosure, to manage the location of the entity for processing the data streams received by the gateway from the WAN network.

As indicated above, the system comprises a data stream processing entity nCDN(tk) able to create segments. In our example, the segments created by the processing entity nCDN(tk) are compatible with the download module HAS.

The processing entity nCDN(tk) has a plurality of multicast sources SMC for retrieving a content item.

To select one of the multicast data sources SMC, the playback device STB, i.e. the module HAS present on the playback device STB, sends a request requesting access to the content item and indicates a desired rendering quality, often expressed in kbits/sec by those skilled in the art. Following receipt, the entity nCDN(tk) addresses (or subscribes to) one multicast server SMC (among a plurality of multicast servers) possessing the content item in the desired quality and, in return, receives the content item from the multicast server in question via the telecommunications network, the Internet in our example; the transmission mode implemented between the multicast server and the processing entity is for example the IPTV (abbreviation for “Internet Protocol television”) mode, known to those skilled in the art. The disclosure is not limited to IPTV mode, but to any other similar transmission modes.

Next, after having received the content item in a given quality, the nCDN(tk) stores the received IP packets in a RAM memory so as to process these packets, the processing consisting, in our example, in dividing the packets into segments, and in encoding each segment so as to obtain segments in the requested quality.

After encoding, the processing entity nCDN, in response, transmits a manifest including the addresses (URLs) of the segments thus created.

It will be seen below where the processing entity nCDN(t) is located in the local area network according to an aspect of the present disclosure.

A brief explanation will be given below about what a segment consists of and what the possible qualities (expressed in Kbits/s) for each segment of a content item are.

A communication network RES enables communication between content sources, in our example multicast servers each offering respective qualities for one and the same content item and the entity nCDN(tk). In our example, the network RES is the Internet.

The playback device STB is connected to the gateway GTW via a communication link LI1 and to a rendering device TV, such as a television screen, via a communication link.

In our example, the link between the playback device STB and the processing entity nCDN(tk) is a point-to-point (or unicast) link.

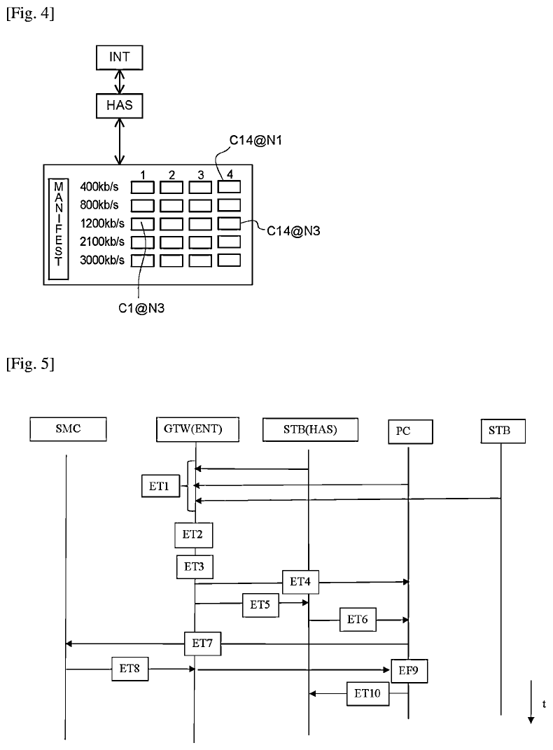

With reference to FIG. 4, various qualities may be encoded for the same content item of a channel, corresponding for example to various encoding bit rates. More generally, the term “quality” will be used to refer to a certain resolution of the digital content item (spatial resolution, temporal resolution, quality level associated with the video and/audio compression) with a certain encoding bit rate. Each quality level is itself divided into time segments on the content server.

The description of these various qualities and the associated temporal segmentation, as well as the content segments, are described for the playback device STB and made available thereto via their Internet addresses (URI: Universal Resource Identifier). All of these parameters (qualities, segment addresses, etc.) are generally grouped together in a parameter file, referred to as a manifest by those skilled in the art. It will be noted that this manifest may be a computer file or a set of pieces of information describing the content item, accessible at a certain address.

The playback device STB, in an HTTP adaptive streaming context, may adapt the access requests that it transmits to the entity nCDN(tk) in order to receive and decode the requested content item at the quality that best corresponds thereto. In our example, if the content items are available at bit rates of 400 kb/s (kilobits per second) (resolution 1, or level 1, denoted N1), 800 kb/s (N21), 1200 kb/s (N31), 2100 kb/s (N4) and 3000 kb/s (N5) and if the client terminal has available a bandwidth of 3000 kb/s, it may request the content item at any bit rate that is lower than this limit, for example 2100 kb/s. Generally speaking, content item number i with quality j is denoted “Ci@Nj” (for example, the jth quality level Nj described in the manifest).

In this example, to display a content item, the playback device STB, i.e. the download module HAS, first interrogates the processing entity nCDN(tk) via the service gateway GTW in order to obtain an IP address of the manifest of the content item on the network. Hereinafter, it will be assumed that this file is a manifest in accordance with the MPEG-DASH standard.

A manifest contains information about the available segments and encoding bit rates. Such a file contains for example, for each segment, multiple different qualities (N1=400 kb/s, N2=800 kb/s, N3=1200 kb/s, etc.) and the access addresses of the segments in question. Once the playback device STB possesses segment addresses corresponding to the desired content item, the playback device STB downloads the segments one after another. It should be noted that this download is carried out here, conventionally, via an HTTP URL, but could also be carried out via a universal resource indicator (URI) describing another protocol (dvb://mysegmentofcontent for example).

Next, the playback device STB decoder, i.e. the module HAS, receives the segments, then decodes them, and requests rendering on the screen of the television set TV.

It should be noted that the content item may be of any nature. The content item is for example a television program with deferred broadcasting, or a video on demand, or a personal video of the user, or any other multimedia content item, to which the disclosure also applies.

The playback device STB is able to be controlled by the user using a remote control. The remote control may be a hardware-based or software-based remote control.

According to the an aspect of the present disclosure, a preliminary step is carried out, during which a management entity ENT determines the location of the processing in the local area network.

Unlike the prior art, in which the entity is stored in the home gateway once and for all, in an aspect of the present disclosure, the location of the entity varies over time; the entity may be stored on a device of choice of the local area network.

It will be seen that the device is chosen on the basis of the performance of the hardware resources and/or software resources for carrying out the data processing.

The steps of one embodiment are described below with reference to FIG. 5. This figure shows axes corresponding 1) to the multicast servers SMC, 2) to the gateway GTW including the management entity ENT, 3) to a set of data processing devices, namely the playback device STB including the download module HAS, the computer PC and the mobile terminal.

A time axis “t” is used to represent the order in which the steps are carried out.

In this FIG. 5, arrowed links are illustrated between the axes in order to illustrate exchanges of messages between the various devices.

It will be assumed in our example that the processing entity nCDN(t1), at the current time t1, is recorded in the memory of the gateway GTW.

In a step ET1, the management entity ENT receives data representative of hardware resources and/or software resources of all or some of the data processing devices of the local area network LAN, including the gateway GTW itself. This step ET1 may be carried out either spontaneously by the data processing devices or upon request of the management entity ENT.

In a step ET2, in our example, the management entity ENT focuses on one hardware resource in particular, namely the RAM volatile memory of the various devices, more particularly the size of these memories in bytes. The disclosure is not limited to this resource, but extends to other resources; for example, other resources may be taken into account, namely the processor power, the communication links available to the data processing devices, for example allowing the reception of a data stream from the network RES, etc.

In a step ET3, the entity ENT classifies the data processing devices STB/PC/MOB, or some of them, according to the sizes of the respective RAM memories and selects, in our example, the processing device having the largest RAM memory size in bytes.

It will be assumed that the selected device is the computer PC.

In a step ET4, at a time t2, the management entity ENT asks to download the processing entity nCDN from the gateway GTW to the selected device PC. The processing entity is referenced nCDN(t2) in FIG. 5.

In a step ET5, the management entity ENT having available the IP address in the LAN of the computer PC designates this IP address and transmits this IP address to the client HAS installed in the playback device STB.

In our example, the computer PC having a Wi-Fi connection is able to communicate directly with the playback device STB.

It should be noted that, if the selected device is not able to communicate directly with the playback device STB, the selected device communicates with the playback device STB via the home gateway GTW.

In our example, at this stage, the computer PC is able to transmit, after processing by the processing entity ENT(t2), segments to the playback device STB in unicast mode.

It will then be assumed that the playback device STB transmits a request for access to a content item. This request is transmitted in a step ET6 to the computer PC equipped with the processing entity nCDN(t2).

The entity nCDN(t2), installed on the computer PC, in a step ET7, then requests access to the content item from a multicast server SRV chosen, in our example, on the basis of a quality provided in the request from the playback device STB. In our example, the request passes through the home gateway.

The home gateway GTW receives in return, in a step ET8, a data stream that it routes to the computer PC so that the processing agent nCDN(t2) is able to process the received data stream.

The processing entity nCDN(t2) then receives IP data packets from the gateway GTW. After receipt, the processing entity nCDN(t2) carries out processing using its processor in a step ET9. The processing is known to those skilled in the art and will not be described further because it is of no interest to the disclosure. It should simply be recalled that the received IP packets are divided into content segments; the segments are then transmitted successively to the playback device STB in a step ET10.

At this stage, the playback device STB is able to receive the segments, decode them and request rendering on the rendering device TV.

Since the capabilities of the devices of the local area network vary over time, the management entity ENT reiterates steps ET1 to ET3. Once the new classification has been obtained, the management entity ENT displaces the processing location. For example, in FIG. 5, the processing entity is displaced to the mobile terminal MOB at a time t3. At that time, steps ET4 to ET10 described above are carried out in the mobile terminal MOB instead of the computer PC.

In FIG. 1, the displacement of the processing location is illustrated by way of a broken curved arrow; a first curved arrow to illustrate a first displacement of the processing entity (nCDN(t1)->nCDN(t2)) and a second curved arrow to illustrate a second displacement of the processing entity (nCDN(t2)->nCDN(t3)). These displacements of the processing location clearly show that the location of the processing entity changes over time as a whole in order to process the data stream received from the network RES as best possible.

The embodiment described above may be subject to variants, including those described below.

According to one variant, the location of the processing entity nCDN(tk) may be determined after each request for access to a content item from the playback device STB. The location may therefore vary very often over time.

It has been seen above in our exemplary embodiment that the processing capabilities include a volatile memory size. In addition, according to one variant, the management entity ENT also takes into account the encoding bit rate associated with the received stream. Indeed, since the encoding bit rate varies over time, the RAM memory requirements during the processing of the data stream also vary. The number of data processing devices suitable for the processing may therefore increase depending on the current encoding bit rate.

It has been seen above that the home gateway GTW routes the data stream to the chosen processing device, in this example the computer PC. As a variant, the data processing device is chosen according to its ability to receive the data stream from a communication network. This mode makes it possible to access the content item if the gateway is unavailable; in this case, the selected device accesses the stream instead of the gateway.

According to another variant, the processing entity nCDN(tk) may be displaced in the local area network. When the management entity ENT designates a device for processing, the processing entity nCDN(tk) is transmitted to the designated device for example from the home gateway GTW.

According to another variant, processing entities nCDN(tk) are stored on the data processing devices of the local area network and are able to be activated on demand. This variant avoids a step of transmitting the processing entity nCDN(tk).

Ultimately, an aspect of the present disclosure relates to a method for managing the processing of a multicast data stream carried out by a processing entity, which, in our example, transforms IP packets originating from the multicast stream into HAS segments transmitted in a unicast stream in the local area network. The local area network comprises a set of data processing devices, and the location of the processing (or transformation) entity changes over time; at a given time, if the processing entity is in a terminal of the local area network, the multicast stream will be received by the gateway GTW and transmitted to the terminal on which the processing entity is installed.

It should be noted that the location is determined via what is known as a self-discovery mechanism. The management entity ENT described above stores the current location in order to direct the stream to the terminal on which the transformation entity is running.

It should be clarified lastly here that the term “entity” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly able to implement a function or a set of functions for the module in question (integrated circuit, chip card, memory card, etc.)

1. A management method implemented by a management entity and comprising:
managing processing of a data stream carried out by a processing entity in a local area network comprising a set of data processing devices, by changing a location of the processing entity in the set of data processing devices over time as a whole.

2. The management method according to claim 1, comprising choosing the location of the processing on the basis of processing capabilities of the processing devices.

3. The management method according to claim 2, wherein the choice is made by comparing processing capabilities of devices of the local area network and by selecting a device based on the comparison.

4. The management method according to claim 2, wherein the processing capabilities include a volatile memory size.

5. The management method according to claim 4, wherein the processing entity is able to process a data stream associated with an encoding bit rate, and the choice of an installation location of the processing entity also depends on said encoding bit rate of the data stream to be processed.

6. The management method according to claim 1, wherein the local area network comprises a home gateway and the home gateway routes the data stream to the location of the processing entity.

7. The management method according to claim 1, wherein the data processing devices are able to receive the data stream from a communication network.

8. A management entity for managing processing of a data stream in a local area network comprising a set of data processing devices, wherein the management entity comprises:
a processor configured to request displacement of a location of the processing in said set of data processing devices.

9. A playback device of the set of processing devices and comprising the management entity as defined in claim 8.

10. A non-transitory computer readable medium comprising program code instructions stored thereon that, when executed by a processor of a management entity, carry out a method comprising:
managing processing of a data stream carried out by a processing entity in a local area network comprising a set of data processing devices, by changing a location of the processing entity in the set of data processing devices over time as a whole.
